(19) United States
(12) Patent Application Publication
(10) Pub. No.: US 2011/0138156 A1
(43) Pub. Date: Jun. 9, 2011

(54) METHOD AND APPARATUS FOR EVALUATING A LOGICAL EXPRESSION AND PROCESSOR MAKING USE OF SAME

(76) Inventors: Tom AWAD, Montreal (CA); Martin LAURENCE, Montreal (CA); Martin FILTEAU, Laval (CA)

(21) Appl. No.: 12/905,753

(22) Filed: Oct. 15, 2010

Related U.S. Application Data
(60) Provisional application No. 61/251,959, filed on Oct. 15, 2009.

(51) Int. Cl. G06F 9/305

(52) U.S. Cl. 712/223; 712/E09.018

(57) ABSTRACT

A method and associated processor suitable for executing machine instructions for evaluating a logical expression are provided. The approach suggested makes use of a memory and an extended set of instructions. The memory, which can be embodied in a general purpose register for example, is for storing information related to an intermediate results obtained in evaluating the logical expression as well as a nesting level of sub-expressions in the logical expression being evaluated. The extended set of instruction allows for initializing and updating the information in that memory. A processor for executing the extended set of instruction is also provided along with a process for generating machine code making use of this extended set of instructions for evaluating a logical expression.

### CROSS-REFERENCE TO RELATED APPLICATION

The present application claims the benefit of priority under 35 USC §119 e) based on U.S. provisional patent application Ser. No. 61/251,959 filed on Oct. 15, 2009 by T. Awad et al. The contents of the aforementioned document are incorporated herein by reference.

### FIELD OF THE INVENTION

The present invention relates generally to the field of processors, and, more specifically, to a method and apparatus for use in encoding logical expressions to generate machine-readable instructions for execution by a processor as well as a processor for executing the machine-readable instructions.

### BACKGROUND

A compiler is a computer program that translates a program written in a high-level language into another language, usually machine readable code that a CPU can execute. Typically, a programmer writes language statements in a high-level language one line at a time using an editor. The appropriate language compiler is then invoked in order to process the program. When executing (running), the compiler first parses (or analyzes) the language statements syntactically one after the other and then, in one or more successive stages or “passes”, builds the output code.

Much general-purpose code is control intensive code, with branches and logical expressions. Executing instructions in order to evaluate logical expressions is costly in terms of processor resources and computing time. The costs escalate with the level of complexity of the logical expression. Various approaches have been proposed so that the resulting encoded logical expressions can be more efficiently executed.

One of the approaches proposed is sometimes referred to as predicated execution of instructions. Predicated execution is conditional execution of instructions based upon a Boolean value called a predicate. Superscalar processors have used predicated execution to exploit instruction-level parallelism (ILP) in control code.

Predicated execution allows generally efficient encoding of logical expressions. Take for example the following logical expression:

X=((((A==1)|(B==2))&(C==3))|(D==4));

This expression may be encoded as follows using a predicated execution approach:

| | | |
|---|---|---|
| | CMPEQ | P1, 1, A |
| [!P] | CMPEQ | P1, 2, B |
| [P1] | CMPEQ | P1, 3, C |
| [!P1] | CMPEQ | P1, 4, D |
| | MOV | X, P1 |

Compare the above to using bitwise AND/OR instructions, which require more instructions and an additional general-purpose register.

| | |
|---|---|
| CMPEQ | R, 1, A |
| CMPEQ | T, 2, B |
| OR | R, T |
| CMPEQ | T, 3, C |
| AND | R, T |
| CMPEQ | T, 4, D |
| OR | R, T |

A deficiency with the use of predicated execution is that it requires significant extensions to the instruction-set and micro-architecture of a processor making use of such an approach. In any practical implementation of a processor there are a limited number of predicate flags that can be implemented limiting the size or depth of the logical expression that can be evaluated with this method. When a logical expression in the code exceeds this size, the compiler used to generate machine code based on this approach has to breakdown the logical expression into pieces to operate with a limited number of predicate flags that are supported by the processor.

In light of the above, it appears that there is a need in the industry for providing a method and associated apparatus for evaluating a logical expression that alleviate at least in part the deficiencies of the prior art.

### SUMMARY

In accordance with a broad aspect, the invention provides a method and apparatus for use in evaluating a logical expression using a general-purpose register and an extended set of instruction.

In accordance with a specific example of implementation, instructions that perform Boolean operations, such as for examples compares or bitwise tests, are extended using an apparatus and/or an extended instruction set to provide functionality for updating a specified general-purpose register the value of which is dependent in part upon the result of a Boolean operation.

In accordance with a first aspect, the invention provides a processor suitable for executing machine instructions. The processor comprises an input for receiving a machine instruction, the received machine instruction defining a first operand, a second operand, a third operand and a function to be applied to the first operand, the second operand and third operand. The processor also comprises a logic module for applying the function to the first operand and second operand to obtain an initial Boolean result and for applying the function to the initial Boolean result and the third operand to derive an updated result. The logic module is also configured for modifying the third operand so that its value corresponds to the updated result.

In accordance with a specific implementation, the processor comprises memory devices in communication with the logic module for storing the first operand, the second operand and the third operand. The memory devices may include, for example, respective registers for storing the first operand, the second operand and the third operand. In a specific implementation, modifying the third operand to correspond to the updated result includes storing the updated result in the register storing the third operand.

In a specific implementation, the function when applied to the initial Boolean result and the third operand is such that the updated result corresponds to one of the initial Boolean result, the third operand and a modified version of the third operand. More particularly, when the function conveys a first function type, the logic module is configured for processing the initial Boolean result to derive the updated result by setting the updated result to correspond to the initial Boolean result. When the function conveys a second function type, the logic module is configured for processing the third operand to set the updated result to correspond to a selected one of the initial Boolean result and the third operand. When the function conveys a third function type, the logic module is configured for processing the third operand to set the updated result to correspond to a selected one of the initial Boolean result and a modified version of the third operand.

In a specific example of implementation, the function defined by the machine instruction includes an operation and an operation modifier. In this specific implementation, the logic module is configured for applying the operation to the first operand and second operand to obtain the initial Boolean result and for applying the operation modifier to the initial Boolean result and the third operand to derive the updated result. In a non-limiting example, the logic module may include a first logic module and a second logic module. The first logic module is for applying the operation to the first operand and second operand to obtain the initial Boolean result. The second logic module, which is in communication with the first logic module, is configured for applying the operation modifier to the initial Boolean result and to the third operand to derive the updated result and for modifying the third operand to correspond to the updated result.

In accordance with a second aspect, the invention provides a processor suitable for executing machine instructions. The processor comprises an input for receiving a machine instruction, the received machine instruction defining a first operand, a second operand, a third operand and a function to be applied to the first operand, the second operand and third operand. The processor also comprises a logic module for applying the function to the third operand to derive a preliminary result indicator. In dependence of the derived preliminary result indicator, the logic module is configured for selectively applying the function to the first operand and second operand to update the derived preliminary result indicator. The logic module is also configured for storing the derived preliminary result indicator in a memory associated with the third operand.

In accordance with a specific implementation, the processor comprises memory devices in communication with the logic module for storing the first operand, the second operand and the third operand. The memory devices may include, for example, respective registers for storing the first operand, the second operand and the third operand.

In a specific implementation, the function when applied is such that the result corresponds to one of a Boolean result obtained by applying the function to the first operand and second operand, the third operand and a modified version of the third operand. More specifically, when the function conveys a first function type, the logic module is configured for updating the preliminary result indicator by setting the derived preliminary result indicator to correspond to a Boolean result obtained by applying the function to the first operand and second operand. When the function conveys a second function type, the logic module is configured for updating the preliminary result indicator to a selected one of the third operand and the Boolean result obtained by applying the function to the first operand and second operand. When the function conveys a third function type, the logic module is configured for updating the preliminary result indicator to a selected one of a modified version of the third operand and the Boolean result obtained by applying the function to the first operand and second operand.

In a specific example of implementation, the function defined by the machine instruction includes an operation and an operation modifier. In this specific implementation, the logic module is configured for applying the operation modifier to the third operand to derive the preliminary result indicator and for applying the operation to the first operand and the second operand to derive a Boolean result. The logic module is also configured for conditionally using the Boolean result to update the preliminary result indicator.

In a specific implementation, the operation modifier is selected from a set of available operation modifiers including at least a first modifier type, a second modifier type and a third modifier type. When the operation modifier conveys a first modifier type, the logic module is configured for updating the preliminary result indicator by setting the derived preliminary result indicator to correspond to the Boolean result. When the operation modifier conveys a second modifier type, the logic module is configured for performing an update of the preliminary result indicator when the preliminary result indicator conveys a pre-determined value, the update of the preliminary result indicator including setting the derived preliminary result indicator to correspond to the Boolean result. When the operation modifier conveys a third modifier type, the logic module is configured for performing an update of the preliminary result indicator so that:
when the preliminary result indicator conveys the pre-determined value, the derived preliminary result indicator is set to correspond to the Boolean result; and
when the preliminary result indicator is different from the pre-determined value, the preliminary result indicator is modified.

In a non-limiting example, the logic module may include a first logic module and a second logic module. The first logic module applies the operation modifier to the third operand to derive the preliminary result indicator. The second logic module applies the operation to the first operand and second operand to obtain the Boolean result and in dependence of the derived preliminary result indicator, selectively updates the derived preliminary result indicator based on the Boolean result. The second logic module also stores the derived preliminary result indicator in a memory associated with the third operand.

In accordance with another aspect, the invention provides process implemented by a processor having a logic module. The process comprises receiving a machine instruction, the received machine instruction defining a first operand, a second operand, a third operand and a function to be applied to the first operand, the second operand and third operand. The process also comprises using the logic module of the processor to apply the function to the first operand and second operand to obtain an initial Boolean result and using the logic module of the processor to apply the function to the initial Boolean result and the third operand to derive an updated result. The process also comprises storing the updated result in a memory unit associated with the third operand so that the third operand is modified to correspond to the updated result.

In accordance with a specific example of implementation, when the function conveys a first function type, the logic module is used for processing the initial Boolean result to derive the updated result by setting the updated result to correspond to the initial Boolean result. When the function conveys a second function type, the logic module is used for processing the third operand to set the updated result to correspond to a selected one of the initial Boolean result and the third operand. When the function conveys a third function type, the logic module is used for processing the third operand to set the updated result to correspond to a selected one of the initial Boolean result and a modified version of the third operand.

In accordance with another aspect, the invention provides a process implemented by a processor having a logic module. The process comprises receiving a machine instruction, the received machine instruction defining a first operand, a second operand, a third operand and a function to be applied to the first operand, the second operand and third operand. The process also comprises using the logic module to apply the function to the third operand to derive a preliminary result indicator and, in dependence of the derived preliminary result indicator, using the logic module to selectively apply the function to the first operand and second operand to update the derived preliminary result indicator. The process also comprises storing the derived preliminary result indicator in a memory associated with the third operand.

In accordance with a specific example of implementation, when the function conveys a first function type, the logic module is used for updating the preliminary result indicator by setting the derived preliminary result indicator to correspond to a Boolean result obtained by applying the function to the first operand and the second operand. When the function conveys a second function type, the logic module is used for updating the preliminary result indicator to a selected one of the third operand and the Boolean result obtained by applying the function to the first operand and second operand. When the function conveys a third function type, the logic module is used for updating the preliminary result indicator to a selected one of a modified version of the third operand and the Boolean result obtained by applying the function to the first operand and second operand.

In accordance with another aspect, the invention provides a computer readable storage medium storing a set of computer-readable instructions. The computer-readable instructions are configured to be executed by a processor having a logic module suitable for executing at least some of the computer-readable instructions in the set. The set of computer-readable instructions includes a machine instruction defining a first operand, a second operand, a third operand and a function to be applied to the first operand, the second operand and third operand. When executed by the logic module of the processor, the machine instruction causes the logic module to:
apply the function to the first operand and second operand to obtain an initial Boolean result;
apply the function to the initial Boolean result and the third operand to derive an updated result; and
store the updated result in a memory of the processor associated with the third operand.

In a specific implementation, the function when applied to the initial Boolean result and the third operand is such that the updated result corresponds to one of the initial Boolean result, the third operand and a modified version of the third operand. More particularly, in accordance with a specific example of implementation, when the function conveys a first function type, the logic module when executing the machine instruction is caused to process the initial Boolean result to derive the updated result by setting the updated result to correspond to the initial Boolean result. When the function conveys a second function type, the logic module when executing the machine instruction is caused to process the third operand to set the updated result to correspond to a selected one of the initial Boolean result and the third operand. When the function conveys a third function type, the logic module when executing the machine instruction is caused to process the third operand to set the updated result to correspond to a selected one of the initial Boolean result and a modified version of the third operand.

In accordance with another aspect, the invention provides a computer readable storage medium storing a set of computer-readable instructions. The computer-readable instructions are configured to be executed by a processor having a logic module suitable for executing at least some of the computer-readable instructions in the set. The set of computer-readable instructions includes a machine instruction defining a first operand, a second operand, a third operand and a function to be applied to the first operand, the second operand and third operand. When executed by the logic module, the machine instruction causes the logic module to:
apply the function to the third operand to derive a preliminary result indicator;
in dependence of the derived preliminary result indicator, selectively apply the function to the first operand and second operand to update the derived preliminary result indicator; and
store the derived preliminary result indicator in a memory of the processor associated with the third operand.

In accordance with a specific example of implementation, when the function conveys a first function type, the logic module when executing the machine instruction is caused to update the preliminary result indicator by setting the derived preliminary result indicator to correspond to a Boolean result obtained by applying the function to the first operand and second operand. When the function conveys a second function type, the logic module when executing the machine instruction is caused to update the preliminary result indicator to correspond to a selected one of the third operand and the Boolean result obtained by applying the function to the first operand and second operand. When the function conveys a third function type, the logic module when executing the machine instruction is caused to update the preliminary result indicator to a selected one of a modified version of the third operand and the Boolean result obtained by applying the function to the first operand and second operand.

In accordance with another aspect, the invention provides a computer program product storing a program element suitable to be executed by a computing apparatus for implementing a process for parsing a logical expression to create a set of computer-readable instructions. The set of computer-readable instructions is suitable for causing a processor to evaluate a Boolean result associated with the logical expression, the logical expression being comprised of a plurality of sub-expressions. The program element when executed by the computing apparatus is configured for processing the sub-expressions in the plurality of sub-expressions to generate the set of computer-readable instructions, the processed sub-expressions being associated with respective nesting levels relative to the logical expression being evaluated. At least one computer readable instruction associated with a sub-expression of the plurality of sub-expressions defines a first operand, a second operand, a third operand and a function to be applied to the first operand, the second operand and third operand. The function defined in the at least one computer readable instruction is such that, when executed by the processor, the third operand is caused to convey information related to a combination of:
an intermediate result of the logical expression being evaluated; and
a level of nesting associated with a sub-expression with which the at least one computer readable instruction is associated.

The set of generated computer-readable instructions is then stored on a memory device.

In accordance with a specific example of implementation, the logical expression processed by the program element is a normalized logical expression in which Boolean operators selected from a set of available Boolean operators are used. In a first specific example, the set of available Boolean operators consists of OR and NOT operators. In a second specific example, the set of available Boolean operators consists of AND and NOT operators.

In accordance with an alternative example of implementation, the program element, when executed by the computing apparatus, is configured for processing the logical expression to derive a normalized logical expression, the normalized logical expression including Boolean operators selected from a set of available Boolean operators, and for generating the set of computer-readable instructions based on sub-expressions in the normalized logical expression.

In accordance with another aspect, the invention provides a computer program product storing a program element suitable to be executed by a computing apparatus for implementing a process for parsing a logical expression to create a set of computer-readable instructions. The set of computer-readable instructions is suitable for causing a processor to evaluate a Boolean result associated with the logical expression, the logical expression being comprised of a plurality of sub-expressions, each sub-expression being associated with a respective nesting level relative to the logical expression being evaluated. The process implemented by the program element when executed by the computing apparatus comprises processing a sub-expression of the plurality of sub-expressions to generate a computer readable instruction. The computer readable instruction defines a function to cause information to be stored in a memory associated with a processor executing the computer readable instruction. The information cause information to be stored in the memory is related to a combination of:
a preliminary result of the logical expression being evaluated; and
a level of nesting associated with the sub-expression processed to generated the least one computer readable instruction.

In accordance with another aspect, the invention provides a computer program product storing a program element suitable to be executed by a computing apparatus for implementing a process for parsing a logical expression to create a set of computer-readable instructions, the set of computer-readable instructions being suitable for causing a processor to evaluate a Boolean result associated with the logical expression. The process implemented by the program element when executed by the computing apparatus comprises processing the logical expression to generate at least one computer readable instruction defining a first operand, a second operand, a third operand and a function to be applied to the first operand, the second operand and third operand. When executed by the processor, the machine instruction causes the processor to apply the function to the first operand and second operand to obtain an initial Boolean result and to apply the function to the initial Boolean result and the third operand to derive an updated result. The machine instruction also causes the processor to store the updated result in a memory of the processor associated with the third operand.

In accordance with a specific example of implementation, the third operand conveys information being related to a combination of a preliminary result of the logical expression being evaluated and a level of nesting associated with the sub-expression processed to generated the least one computer readable instruction.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

A detailed description of examples of implementation of the present invention is provided herein below with reference to the following drawings, in which:

FIG. 1A is block diagrams of an apparatus for use in a processor suitable for executing machine instructions in accordance with a first specific example of implementation of the invention;

FIG. 1B is block diagrams of an apparatus for use in a processor suitable for executing machine instructions in accordance with a second specific example of implementation of the invention. This block diagram show an apparatus 210 coupled to the output of a Boolean operation 20. The inputs to the apparatus 210 are the single bit result from the Boolean operation, the third operand 230 and the operation modifier 220. The apparatus 210 produces result 240. The result may be stored in the same register as the third operand 230.

FIG. 1C is block diagrams of an apparatus for use in a processor suitable for executing machine instructions in accordance with a third specific example of implementation of the invention;

FIG. 2 shows a 32-bit register for holding an operand conveying information in accordance with a specific example of implementation of the invention. The operand has an N-bit nesting count supporting a maximum nesting level of 2^{N-1};

FIGS. 3A and 3B are flow diagram showing processes for executing an instruction in accordance with specific examples of implementation of the invention;

FIG. 4 shows a computer program product and processor for parsing a logical expression to create a set of computer-readable instructions in accordance with a specific example of implementation of the invention;

FIG. 5 shows a computer program product and an associated processor for the execution of the computer program product including a set of computer-readable instructions in accordance with a specific example of implementation of the invention;

FIG. 6 is a block diagram of a circuit including a processor having a logic unit for applying an instruction in accordance with a specific example of implementation of the invention.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

A typical implementation of assembly level conditional instructions in a processor compare either two (2) registers or a single register against an immediate value or state to produce a one bit result (true or false) that is place in a result register. For example an expression:

CMPNE r3,r1,r2

would set r3 to “1” (true) if r1 were not equal to r2 and “0” if r1 equaled r2.

In accordance with a specific example, proposed new instructions are provided in which the logical evaluation would manipulate an N-bit nesting count (ncnt) to update it by each instruction composing the terms of the logical expression. The ncnt provides an indication of whether or not the result of the logical expression is determinate and, optionally, provides an indication of the nesting level of the instruction within the overall logical expression that is being evaluated.

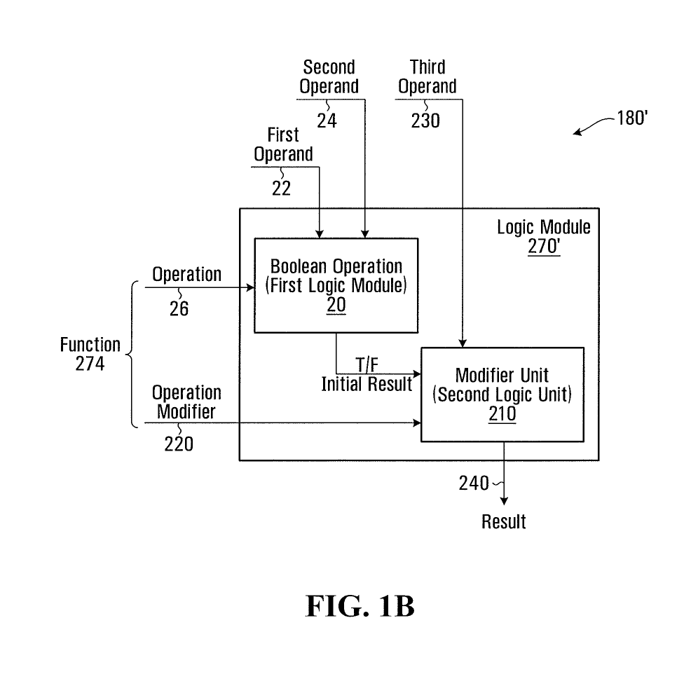

FIG. 2 of the drawings shows a 32-bit register for holding an operand for storing the N-bit nesting count (ncnt). The operand has an N-bit nesting count supporting a maximum nesting level of 2^{N-1}. The register for storing ncnt may be a general purpose register in a processor or, alternatively, may be a dedicated register for use in storing ncnt. As a further optimization, the sign bit (S) of the register for storing ncnt can optionally be set to one when the nesting count is not zero. It is zero otherwise. This enables a single bit evaluation of the state of the conditional expression evaluation to always be available. This would allow, for example, conditional jumps based on the state of the sign bit.

In the exemplary embodiment described here, the logical expression being evaluated is expressed using only combinations of OR operands and NOT operands. “ncnt” is defined so that:
if the ncnt is zero, the result of the sub-expression currently being evaluated within the overall logical expression is not determinate and further terms are needed to evaluate the result of the current sub-expression;
if the ncnt is non-zero, the result of the sub-expression currently being evaluated within the overall logical expression is determinate and subsequent terms of the sub-expression have no effect on the final result of the sub-expression.

In a first specific example of implementation, three types of operation manipulations (modifiers) are used to implement a logical evaluation process using the N-bit nesting count (ncnt):
start (.S),
continue (.C)
pop (.P)

For example the CMPNE (compare-not-equal) operation would be modified using the above modifiers and denoted by adding the .S, .C or .P to the instruction. For example CMPNE.P would indicate the pop modifier should be applied to the operation.

It will be observed that each distinct combination of an operation (example CMPNE) and operation modifier (example .S, .C or .P) defines a new function.

The specific operation modifiers in accordance with a specific example are defined as follows:

### Start (.S)

The ncnt is set to the result of the Boolean operation. If the result is true, ncnt is set to one. Otherwise, it is set to zero. This update type is used to initialize the logical expression operand at the start of an expression evaluation.

### Continue (.C)

If ncnt is zero, it is set to the result of the Boolean operation. Otherwise, it remains unchanged. This update type is used to continue the expression evaluation at the same nesting level.

### Pop (.P)

If ncnt is zero, it is set to the result of the Boolean operation. Otherwise, it is decremented by one. This update type is used to terminate the expression evaluation at the current level and resume at a lower nesting level.

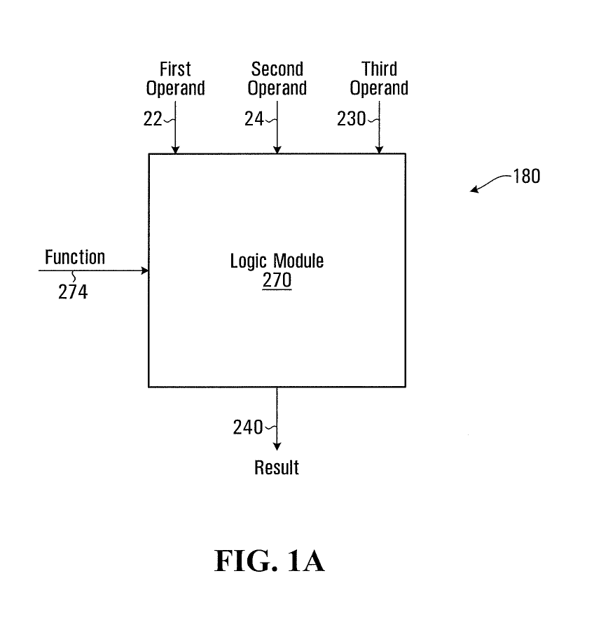

FIGS. 1A, 1B and 1C of the drawings depict embodiments of processors for executing machine instructions including the new instructions described above.

More specifically, with reference to FIG. 1A, there is shown a processor 180 suitable for executing machine instructions. The processor 180 includes inputs for receiving a machine instruction, the received machine instruction defining a first operand 22, a second operand 24, a third operand 230 and a function 274 to be applied to the first operand 22, the second operand 24 and third operand 230 by a logic module 270 to derive a result 240. The result 240 is used to modify a memory unit (not shown in FIG. 1A) associated with the third operand 230. In this example the third operand is used to store “ncnt” defined above.

In accordance with a first approach, logic module 270 is configured to apply the function 274 to the first operand and second operand to obtain an initial Boolean result. When the function 274 conveys a first function type, the logic module 270 is configured for processing the initial Boolean result to derive the result 240 by setting the result 240 to correspond to the initial Boolean result. In a non-limiting example, the first function type is a function as modified by the (.S) extension as described above. When the function 274 conveys a second function type, the logic module 270 is configured for processing the third operand 230 to set the result 240 to correspond to a selected one of the initial Boolean result and the third operand 230. In a non-limiting example, the first function type is a function as modified by the (.C) extension as described above. When the function conveys a third function type, the logic module is configured for processing the third operand 230 to set the result 240 to correspond to a selected one of the initial Boolean result and a modified version of the third operand. In the embodiment described the modified version of the third operand corresponds to the third operand 230 decremented by one (1). In a non-limiting example, the first function type is a function as modified by the (.P) extension as described above.

FIG. 1B depicts a specific example of a processor 180′, analogous to processor 180 of FIG. 1A, including an implementation of the logic module 270 for FIG. 1A in accordance with the first approach described above, identified as logic module 270′ in FIG. 1B for the purpose of clarity. In accordance with this first specific example, the function 274 includes an operation 26 and an operation modifier 220. The logic module 270′ is configured for applying the operation 26 to the first operand 22 and second operand 24 to obtain the initial Boolean result and for applying the operation modifier 220 to the initial Boolean result and the third operand 230 to derive the result 240. In the embodiment depicted first logic module 20 applies the operation 26 to the first operand and second operand to obtain the initial Boolean result and second logic module 210 applies the operation modifier to the initial Boolean result and the third operand 230 to derive the result 240.

The operation modifier is selected from a set of available operation modifier type, in this non-limiting example the start (.S) modifier type, continue (.C) modifier type and pop (.P) modifier type.

The first logic module 20 may be implemented in accordance with conventional boolean (logic) modules which are well known in the art and will not be described further here.

The second logic module 210 is configured for generating the result 240 in dependence on the operation modifier. In particular, when the operation modifier 220 conveys the start (.S) modifier type, the second logic module 20 is configured for processing the initial Boolean result to derive the updated result by setting the result to correspond to the initial Boolean result. When the operation modifier conveys the continue (.C) modifier type, the second logic module 20 is configured for processing the third operand 230 to set the result 240 to correspond to a selected one of the initial Boolean result and the third operand 230. When the operation modifier 220 conveys the pop (.P) modifier type, the logic module 210 is configured for processing the third operand 230 to set the result 240 to correspond to a selected one of the initial Boolean result and a modified version of the third operand 230. The modified version in this case corresponds to the third operand 230 being decremented by one (1).

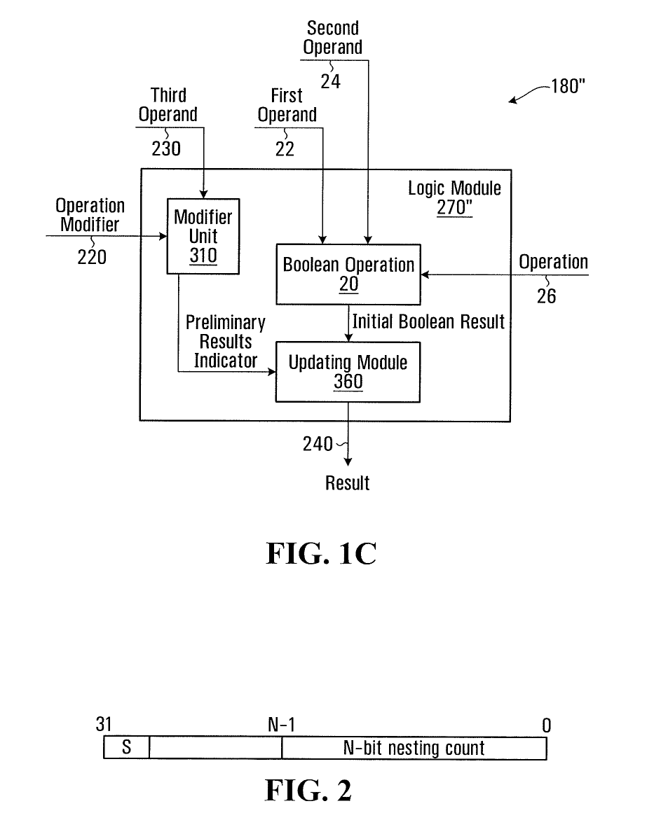

FIG. 3A is a flow diagram depicting a process implemented by processor 180′ depicted in FIG. 1B. At step 500 a machine instruction is received by the processor 180′. The machine instruction defines a first operand, a second operand, a third operand and a function to be applied to the first operand, the second operand and third operand. At step 502, the function is applied by the first logic module 20 (shown in FIG. 1B) to the first operand and second operand to obtain an initial Boolean result. At step 504, the function is applied to the initial Boolean result and the third operand to derive an updated result. At step 506, the updated result is stored in a memory unit associated with the third operand so that the third operand is modified to correspond to the updated result.

Returning now to FIG. 1A, in accordance with a second approach, logic module 270 is configured to apply the function 274 to the third operand 230 to derive a preliminary result indicator. In dependence of the derived preliminary result indicator, logic module 270 is configured to selectively applying the function 274 to the first operand 22 and second operand 24 to update the derived preliminary result indicator and obtain the result 240.

FIG. 1C depicts a specific example of a processor 180″, analogous to processor 180 of FIG. 1A, including an implementation of the logic module 270 for FIG. 1A in accordance with the second approach described above, identified as logic module 270″ in FIG. 1C for the purpose of clarity. In accordance with this second specific example, the function 274 includes an operation 26 and an operation modifier 220. The logic module 270″ is configured for applying the operation modifier 220 to the third operand 230 to derive a preliminary result indicator. The logic module 270″ is also configured for, in dependence of the derived preliminary result indicator, selectively applying the operation 26 to the first operand 22 and second operand 24 to update the derived preliminary result indicator and derive the result 240.

In the embodiment depicted, first logic module 20′ applies the operation 26 to the first operand 22 and second operand 24 to obtain an initial Boolean result, second logic module 310 applies the operation modifier to the third operand 230 to derive the preliminary result indicator. A third logic module 360, referred to as the updating module 360, processes the preliminary result indicator and the initial Boolean result to derive the result 240.

The operation modifier 220 is selected from a set of available operation modifier type, in this example the start (.S) modifier type, the continue (.C) modifier type and the pop (.P) modifier type.

The first logic module 20 may be implemented in accordance with conventional Boolean (logic) modules which are well known in the art and which as such will not be described further here.

The second logic module 310 and the updating module 360 are configured for generating the result in according with the operation modifier. In particular, when the operation modifier 220 conveys the start (.S) modifier type, the second logic module 310 and the updating module 360 are configured for deriving a result 340 that corresponds to the initial Boolean result. When the operation modifier conveys continue (.C) modifier type, the second logic module 310 and the updating module 360 are configured for deriving a result 340 that corresponds to the initial Boolean result when the third operand 230 conveys a pre-determined value, and for the deriving a result 340 that corresponds to the third operand 230 otherwise. In a specific implementation the pre-determined value is “0”. When the operation modifier conveys the pop (.P) modifier type, the second logic module 310 and the updating module 360 are configured for deriving a result 340 that corresponds to;
the initial Boolean result when the third operand 230 conveys a pre-determined value. In a specific implementation the pre-determined value is “0”;
a modified version of the third operand 230 otherwise. The modified version in this case corresponds to third operand 230 decremented by one (1).

FIG. 3B is a flow diagram depicting a process implemented by processor 180″ depicted in FIG. 1C. At step 550 a machine instruction is received by the processor 180″. The machine instruction defines a first operand, a second operand, a third operand and a function to be applied to the first operand, the second operand and third operand. At step 552, the function is applied to the third operand to derive a preliminary result indicator. At step 554, in dependence of the derived preliminary result indicator, the function is selectively applied to the first operand and the second operand to update the derived preliminary result indicator. At step 556, the derived preliminary result indicator is stored in a memory unit associated with the third operand so that the third operand is modified to correspond to the derived preliminary result indicator.

It is to be appreciated by the person skilled in the art that the functionality of the logic units 270 270′ and 270″ described with reference to FIGS. 1A, 1B and 1C may be implemented using any suitable hardware components and many possible implementations will become readily apparent to the person skilled in the art in light of the present description. The specific combination of hardware elements and configuration used in practical implementations for achieving the above described functionality is not critical to the invention and therefore will not be described in detail here.

### Method for Generating Computer-Readable Code

To use the above described processors to evaluate a logical expression, a generalized method is introduced here for generating a set of computer-readable instructions which makes use of the new instructions described above.

In particular, a process for parsing a logical expression to generate a set of computer-readable instructions being suitable for causing a processor to evaluate a Boolean result associated with the logical expression. The generated set of computer-readable instructions make use of the augmented instruction set described above in order to makes use of a register for storing information (in this example ncnt) related to a combination of:
a preliminary result of the logical expression being evaluated; and
a level of nesting associated with the sub-expression processed to generated the least one computer readable instruction.

Generally speaking, the logical expression is comprised of a plurality of sub-expressions, each sub-expression being associated with a respective nesting level relative to the logical expression being evaluated. The process comprises processing the sub-expressions of the plurality of sub-expressions to generate computer readable instructions.

For the purpose of the present description, a logical expression that is expressed using either only OR and NOT logical operators or only AND and NOT logical operators is referred to as a “normalized” logical expression.

In the present description a basic method configured to be applied to a logical expression that has been reduced to be expressed using only OR and NOT logical operators will be described. It will become readily apparent to the person skilled in the art on how to apply a modified alternative version of the method described here to a logical expression that has been reduced to be expressed using only AND and NOT logical operators and as such this alternative version of the method will not be described in detail here.

If the logical expression to be evaluated is not a normalized logical expression, it can ne normalized so that it is expressed using only OR and NOT logical operators through the use of well known De Morgan's Law of logical equivalence. For example the expression:

result=(A [symbol] B) [symbol] (C [symbol] 0)

can be converted to:

result= [symbol] ( [symbol] A [symbol] [symbol] B) [symbol] [symbol] ( [symbol] C [symbol] [symbol] D)

In another example, the expression:

result=A [symbol] (((B [symbol] C) [symbol] D) [symbol] E)

can be converted to:

result=A [symbol] [symbol] ( [symbol] ( [symbol] ( [symbol] B [symbol] [symbol] C) [symbol] D) [symbol] [symbol] E)

In accordance with an example of implementation of the invention, the expression can then be parsed left to right in the following manner:
1. Initialize ncnt to zero once at the beginning of parsing an expression
2. For each entry into a sub-expression (“(”) if ncnt is greater than 0 increment ncnt by 1. Note that entering the first sub-expression after initialization ncnt will never be greater than 0.
3. For each conditional evaluation in a sub-expression, if ncnt equals zero, ncnt is set to the one bit result of the conditional evaluation (ncnt value would become 1 or 0).
4. For each exit of a sub-expression (“)”) if ncnt is greater than 1 decrement ncnt by 1.
5. For each evaluated sub-expression (after performing exit step above) if ncnt is less than or equal to one, ncnt is set to the one bit result of the conditional evaluation of the sub-expression

Using the operation modifiers described above, we note that:
Start (.S) is the combination of steps 1, 2, and 3
Continue (.C) is step 3
Pop (.P) is the combination of steps 4 and 5.

For the purpose of illustration we will apply the described parsing approach to two example logical expressions using the following notation:
A, B, C, D: boolean variables with a value of 0 or 1
result: register
ncnt: general purpose register used for N-Bit nesting count
[symbol] : not
[symbol] : and
[symbol] : or
condition [symbol] expression (if condition is true then do expression, otherwise do nothing)

### FIRST EXAMPLE

Applying the above approach to the example expression (the sub-expressions marked in bold is the one being parsed):

result = [symbol] ( [symbol] A [symbol] [symbol] B) [symbol] [symbol] ( [symbol] C [symbol] [symbol] D)

| | |
|---|---|
| ncnt = 0 | (1) Initialize ncnt register |
| ncnt > 0 [symbol] ncnt := ncnt + 1 | (2) Parse open parentheses (“(”) |
| | [symbol] ( [symbol] A [symbol] [symbol] B) [symbol] [symbol] ( [symbol] C [symbol] [symbol] D) |
| | note: will always be “0” after initialization |
| ncnt = 0 [symbol] ncnt := [symbol] A | (3) Evaluate condition in sub-expression |
| | [symbol] ( [symbol] A [symbol] [symbol] B) [symbol] [symbol] ( [symbol] C [symbol] [symbol] D) |
| ncnt = 0 [symbol] ncnt := [symbol] B | (3) Evaluate condition in sub-expression |
| | [symbol] ( [symbol] A [symbol] [symbol] B) [symbol] [symbol] ( [symbol] C [symbol] [symbol] D) |
| ncnt > 1 [symbol] ncnt := ncnt − 1 | (4) Parse close parentheses |
| | [symbol] ( [symbol] A [symbol] [symbol] B) [symbol] [symbol] ( [symbol] C [symbol] [symbol] D) |
| ncnt ≦ 1 [symbol] ncnt := [symbol] ncnt | (5) Evaluate condition of sub-expression |
| | [symbol] ( [symbol] A [symbol] [symbol] B) [symbol] [symbol] ( [symbol] C [symbol] [symbol] D) |
| ncnt > 0 [symbol] ncnt := ncnt + 1 | (2) Parse open parentheses (“(”) |
| | [symbol] ( [symbol] A [symbol] [symbol] B) [symbol] [symbol] ( [symbol] C [symbol] [symbol] D) |
| ncnt = 0 [symbol] ncnt := [symbol] C | (3) Evaluate condition in sub-expression |
| | [symbol] ( [symbol] A [symbol] [symbol] B) [symbol] [symbol] ( [symbol] C [symbol] [symbol] D) |
| ncnt = 0 [symbol] ncnt := [symbol] D | (3) Evaluate condition in sub-expression |
| | [symbol] ( [symbol] A [symbol] [symbol] B) [symbol] [symbol] ( [symbol] C [symbol] [symbol] D) |
| ncnt > 1 [symbol] ncnt := ncnt − 1 | (4) Parse close parentheses |
| | [symbol] ( [symbol] A [symbol] [symbol] B) [symbol] [symbol] ( [symbol] C [symbol] [symbol] D) |
| ncnt ≦ 1 [symbol] ncnt := [symbol] ncnt | (5) Evaluate condition of sub-expression |
| | [symbol] ( [symbol] A [symbol] [symbol] B) [symbol] [symbol] ( [symbol] C [symbol] [symbol] D) |

The above listing can be simplified in the following manner

$$[ \begin{matrix}ncnt := 0 \\ ncnt > 0 ⇒ ncnt := ncnt + 1 \\ ncnt = 0 ⇒ ncnt := A\end{matrix} ] \begin{matrix}( combined ) \\ ( \begin{matrix}removed because ncnt always \\ 0 at beginning of evaluation\end{matrix} ) \\ ( combined )\end{matrix}$$

$$ncnt := A \\ [ \begin{matrix}ncnt = 0 ⇒ ncnt := B \\ ncnt > 1 ⇒ ncnt := ncnt - 1 \\ ncnt \leq 1 ⇒ ncnt := ncnt\end{matrix} ] \begin{matrix}( combined ) \\ ( combined ) \\ ( combined )\end{matrix}$$

$$ncnt = 0 ⇒ ncnt := B ncnt > 0 ⇒ ncnt := ncnt - 1$$

$$ncnt > 0 ⇒ ncnt := ncnt + 1$$

$$ncnt = 0 ⇒ ncnt := C \\ [ \begin{matrix}ncnt = 0 ⇒ ncnt := D \\ ncnt > 1 ⇒ ncnt := ncnt - 1 \\ ncnt \leq 1 ⇒ ncnt := ncnt\end{matrix} ] \begin{matrix}( combined ) \\ ( combined ) \\ ( combined )\end{matrix}$$

$$ncnt = 0 ⇒ ncnt := D ncnt > 0 ⇒ ncnt := ncnt - 1$$

The above operations can be expressed in assembly language for execution by a processor. In order to illustrate this, consider the following conventions:
s0 “first operand”, a source of an operand for an instruction, may be either a register or an immediate value
s1 “second operand”, a source of an operand for an instruction, may be either a register or an immediate value
ds2 “third operand”, the destination register of an instruction and optionally a source register of an instruction

| | | |
|---|---|---|
| CMPNE | ds2, s1, s0 | Compare Not Equal |
| | | if s1 is not equal to s2, ds2 is set to 1 otherwise 0 |
| CMPEQ | ds2, s1, s0 | Compare Equal |
| | | if s1 is equal to s2, ds2 is set to 1 otherwise 0 |
| CADDNZ | ds2, s1, s0 | Conditional Add Not Zero |
| | | if s0 is not equal to zero, |
| | | ds2 is set to s0 plus s1 otherwise 0 |

By applying the proposed modifiers and converting to assembly language this becomes:

| | | |
|---|---|---|
| CMPNE.S | ncnt, 1, A | ncnt = 0 |
| | | ncnt > 0 [symbol] ncnt := ncnt + 1 |
| | | ncnt = 0 [symbol] ncnt := [symbol] A |
| CMPEQ.P | ncnt, 1, B | ncnt = 0 [symbol] ncnt := [symbol] B |
| | | ncnt > 1 [symbol] ncnt := ncnt − 1 |
| | | ncnt ≦ 1 [symbol] ncnt := [symbol] ncnt |
| CADDNZ | ncnt, 1, ncnt | ncnt > 0 [symbol] ncnt := ncnt + 1 |
| CMPNE.C | ncnt, 1, C | ncnt = 0 [symbol] ncnt := [symbol] C |
| CMPEQ.P | ncnt, 1, D | ncnt = 0 [symbol] ncnt := [symbol] D |
| | | ncnt > 1 [symbol] ncnt := ncnt − 1 |
| | | ncnt ≦ 1 [symbol] ncnt := [symbol] ncnt |

After the last instruction ncnt contains the one bit result of the original expression.

### SECOND EXAMPLE

Applying the above process to the following second expression (the sub-expressions marked in bold is the one being parsed):

result=A [symbol] [symbol] ( [symbol] ( [symbol] ( [symbol] B [symbol] [symbol] C) [symbol] D) [symbol] [symbol] E)

we get the following:

| | |
|---|---|
| ncnt = 0 | (1) Initialize ncnt register |
| ncnt = 0 [symbol] ncnt := A | (3) Evaluate condition in sub-expression |
| | A [symbol] [symbol] ( [symbol] ( [symbol] ( [symbol] B [symbol] [symbol] C) [symbol] D) [symbol] [symbol] E) |
| ncnt > 0 [symbol] ncnt := ncnt + 1 | (2) Parse open parentheses (“)”) |
| | A [symbol] [symbol] ( [symbol] ( [symbol] ( [symbol] B [symbol] [symbol] C) [symbol] D) [symbol] [symbol] E) |
| ncnt > 0 [symbol] ncnt := ncnt + 1 | (2) Parse open parentheses (“)”) |
| | A [symbol] [symbol] ( [symbol] ( [symbol] ( [symbol] B [symbol] [symbol] C) [symbol] D) [symbol] [symbol] E) |
| ncnt > 0 [symbol] ncnt := ncnt + 1 | (2) Parse open parentheses (“)”) |
| | A [symbol] [symbol] ( [symbol] ( [symbol] ( [symbol] B [symbol] [symbol] C) [symbol] D) [symbol] [symbol] E) |
| ncnt = 0 [symbol] ncnt := [symbol] B | (3) Evaluate condition in sub-expression |
| | A [symbol] [symbol] ( [symbol] ( [symbol] ( [symbol] B [symbol] [symbol] C) [symbol] D) [symbol] [symbol] E) |
| ncnt = 0 [symbol] ncnt := [symbol] C | (3) Evaluate condition in sub-expression |
| | A [symbol] [symbol] ( [symbol] ( [symbol] ( [symbol] B [symbol] [symbol] C) [symbol] D) [symbol] [symbol] E) |
| ncnt >1 [symbol] ncnt := ncnt − 1 | (4) Parse close parentheses (“)”) |
| | A [symbol] [symbol] ( [symbol] ( [symbol] ( [symbol] B [symbol] [symbol] C) [symbol] D) [symbol] [symbol] E) |
| ncnt ≦ 1 [symbol] ncnt := [symbol] ncnt | (5) Evaluate condition of sub-expression |
| | A [symbol] [symbol] ( [symbol] ( [symbol] ( [symbol] B [symbol] [symbol] C) [symbol] D) [symbol] [symbol] E) |
| ncnt = 0 [symbol] ncnt := D | (3) Evaluate condition in sub-expression |
| | A [symbol] [symbol] ( [symbol] ( [symbol] ( [symbol] B [symbol] [symbol] C) [symbol] D) [symbol] [symbol] E) |
| ncnt >1 [symbol] ncnt := ncnt − 1 | (4) Parse close parentheses (“)”) |
| | A [symbol] [symbol] ( [symbol] ( [symbol] ( [symbol] B [symbol] [symbol] C) [symbol] D) [symbol] [symbol] E) |
| ncnt ≦ 1 [symbol] ncnt := [symbol] ncnt | (5) Evaluate condition of sub-expression |
| | A [symbol] [symbol] ( [symbol] ( [symbol] ( [symbol] B [symbol] [symbol] C) [symbol] D) [symbol] [symbol] E) |
| ncnt = 0 [symbol] ncnt := [symbol] E | (3) Evaluate condition in sub-expression |
| | A [symbol] [symbol] ( [symbol] ( [symbol] ( [symbol] B [symbol] [symbol] C) [symbol] D) [symbol] [symbol] E) |
| ncnt >1 [symbol] ncnt := ncnt − 1 | (4) Parse close parentheses (“)”) |
| | A [symbol] [symbol] ( [symbol] ( [symbol] ( [symbol] B [symbol] [symbol] C) [symbol] D) [symbol] [symbol] E) |
| ncnt ≦ 1 [symbol] ncnt := [symbol] ncnt | (5) Evaluate condition of sub-expression |
| | A [symbol] [symbol] ( [symbol] ( [symbol] ( [symbol] B [symbol] [symbol] C) [symbol] D) [symbol] [symbol] E) |

The above can be simplified in the following manner

$$[ \begin{matrix}ncnt := 0 \\ ncnt = 0 ⇒ ncnt := A\end{matrix} ] \begin{matrix}( combined ) \\ ( combined )\end{matrix}$$

$$ncnt := A \\ [ \begin{matrix}ncnt > 0 ⇒ ncnt := ncnt + 1 \\ ncnt > 0 ⇒ ncnt := ncnt + 1 \\ ncnt > 0 ⇒ ncnt := ncnt + 1\end{matrix} ] \begin{matrix}( combined ) \\ ( combined ) \\ ( combined )\end{matrix}$$

$$ncnt > 0 ⇒ ncnt := ncnt + 3$$

$$ncnt = 0 ⇒ ncnt := B \\ [ \begin{matrix}ncnt = 0 ⇒ ncnt := C \\ ncnt > 1 ⇒ ncnt := ncnt - 1 \\ ncnt \leq 1 ⇒ ncnt := ncnt\end{matrix} ] \begin{matrix}( combined ) \\ ( combined ) \\ ( combined )\end{matrix}$$

$$ncnt = 0 ⇒ ncnt := C ncnt > 0 ⇒ ncnt := ncnt - 1 \\ [ \begin{matrix}ncnt = 0 ⇒ ncnt := D \\ ncnt > 1 ⇒ ncnt := ncnt - 1 \\ ncnt \leq 1 ⇒ ncnt := ncnt\end{matrix} ] \begin{matrix}( combined ) \\ ( combined ) \\ ( combined )\end{matrix}$$

$$ncnt = 0 ⇒ ncnt := D ncnt > 0 ⇒ ncnt := ncnt - 1 \\ [ \begin{matrix}ncnt = 0 ⇒ ncnt := E \\ ncnt > 1 ⇒ ncnt := ncnt - 1 \\ ncnt \leq 1 ⇒ ncnt := ncnt\end{matrix} ] \begin{matrix}( combined ) \\ ( combined ) \\ ( combined )\end{matrix}$$

$$ncnt = 0 ⇒ ncnt := E ncnt > 0 ⇒ ncnt := ncnt - 1$$

By applying the proposed modifiers and converting to assembly this becomes:

| | | |
|---|---|---|
| CMPEQ.S | ncnt, 1, A | ncnt = 0 |
| | | ncnt = 0 [symbol] ncnt := A |
| CADDNZ | ncnt, 3, ncnt | ncnt > 0 [symbol] ncnt := ncnt + 1 |
| | | ncnt > 0 [symbol] ncnt := ncnt + 1 |
| | | ncnt > 0 [symbol] ncnt := ncnt + 1 |
| CMPNEQ.C | ncnt, 1, B | ncnt = 0 [symbol] ncnt := [symbol] B |
| CMPEQ.P | ncnt, 1, C | ncnt = 0 [symbol] ncnt := [symbol] C |
| | | ncnt > 1 [symbol] ncnt := ncnt − 1 |
| | | ncnt ≦ 1 [symbol] ncnt : [symbol] ncnt |
| CMPNE.P | ncnt, 1, D | ncnt = 0 [symbol] ncnt := D |
| | | ncnt > 1 [symbol] ncnt := ncnt − 1 |
| | | ncnt ≦ 1 [symbol] ncnt := [symbol] ncnt |
| CMPEQ.P | ncnt, 1, E | ncnt = 0 [symbol] ncnt := [symbol] E |
| | | ncnt > 1 [symbol] ncnt := ncnt − 1 |
| | | ncnt ≦ 1 [symbol] ncnt := [symbol] ncnt |

After the last instruction executes, ncnt contains the one bit result of the original expression.

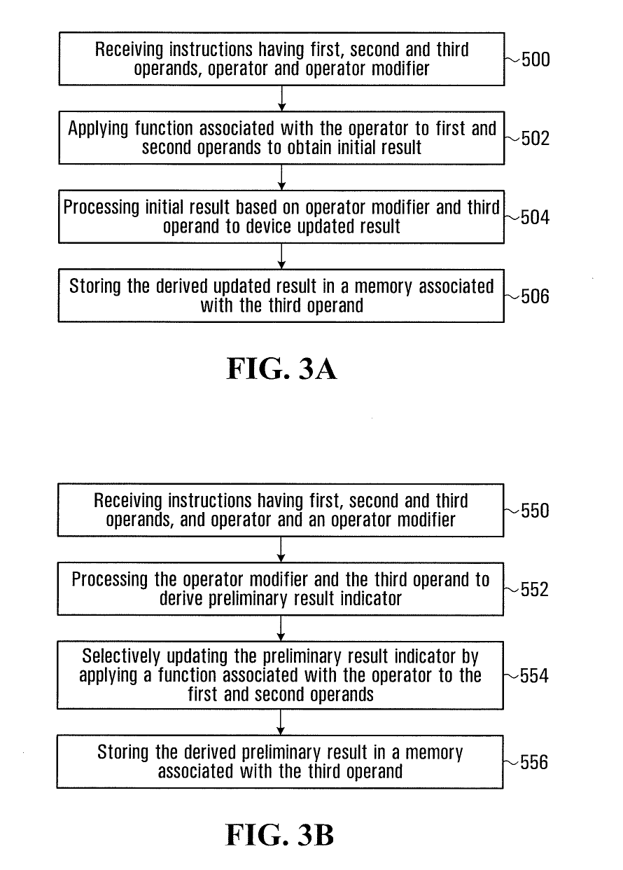

The parsing approach for parsing a logical expression described above may be implemented by a computer program, for example as part of a compiler, and used for parsing a logical expression to create a set of computer-readable instructions to evaluate the result of the logical expression. FIG. 4 of the drawings depicts a computer readable storage medium 650 storing a program element 658 suitable to be executed by a computing apparatus, depicted as processor 652. The program element 658 when executing on the processor 658 implements the process of the type described above for parsing a logical expression, such as logical expression 654 stored on a memory 660, to create a set of computer-readable instructions 656 for evaluating the result of the logical expression. The derived set of computer-readable instructions 656 is then stored in a memory 662 for use by a processor having a logic unit of the type described earlier, for example, in connection with any one of FIGS. 1A, 1B and 1C.

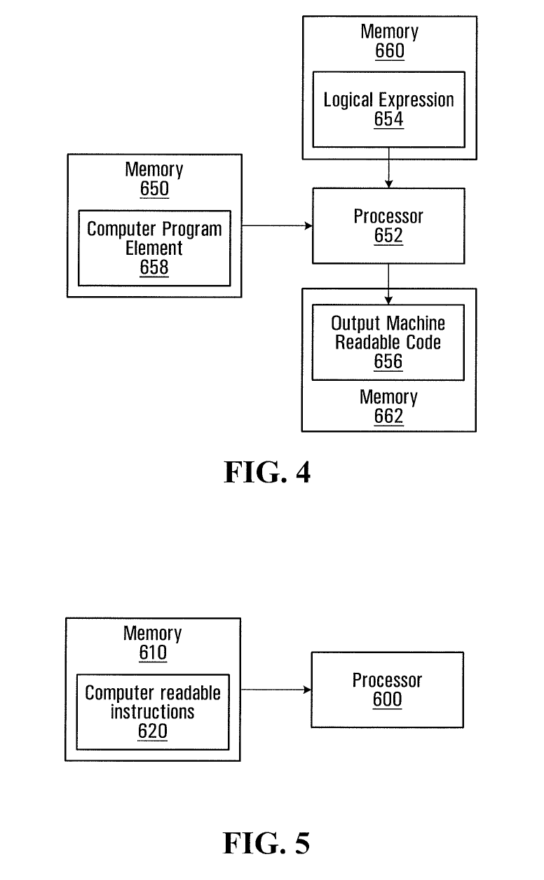

FIG. 5 shows a computer readable storage medium 610 storing a program element 620 including a set of computer-readable instructions generated according to the process described above. FIG. 5 also depicts a processor 600 suitable for executing the program element 620. In a non-limiting example the processor 600 may include an apparatus of the type described in FIG. 1A, 1B or 1C.

Although the specific example of implementation described has described a method applied to a logical expression that has been reduced to be expressed using only OR and NOT logical operators, alternative implementations of the parsing method can also be applied to a logical expression that has been reduced to be expressed using only AND and NOT. This type of conversion and can be achieved for any expression through the use of well known De Morgan's Law of logical equivalence. A slightly modified approach to the one described above for parsing the Boolean expression would be applied. Such a modified approach will be readily apparent to the person skilled in the art in light of the present description and will hence not be described in further detail here.

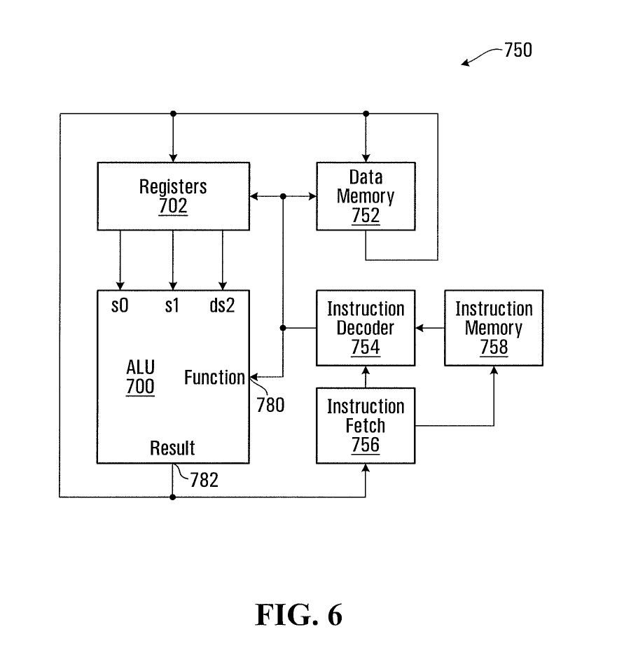

### Processing Circuit 750 (FIG. 6)

FIG. 6 is a block diagram of a circuit 750 having a logic unit (ALU) 700 for applying an instruction in accordance with the above described functionality. For example the functionality of the apparatus described with reference to FIG. 1A, 1B or 1C may be integrated as part of logic unit 700. As depicted, the circuit 750 includes and instruction memory 758 for storing a set of machine readable instruction including instructions of the types described in the present application. The circuit 750 also includes first circuitry 756 for fetching a next instruction to be executed from the instruction memory 758 and second circuitry 754 for decoding an instruction fetched from the instruction memory 758 into a format that is suitable to be processed by the ALU 700. The circuit 750 also includes a data memory 752. In accordance with an example of implementation of the invention, the instruction fetched from memory 758 defines a first operand (S0), a second operand (S1), a third operand (DS2) and a function to be applied to the first operand, the second operand and third operand. The values for the first operand (S0), the second operand (S1) and the third operand (DS2) are provided to the ALU 700 through Registers 702.

The values may be already present in the Registers 702 and/or may be part of the instruction fetched from memory 758 and loaded into the Registers 702. The function defined by the instruction fetched from memory 758 is provided to the ALU 700 at 780. The ALU 700 is configured to apply the function 780 to the first operand (S0), second operand (S1) and third operand (S2) to obtain a result 782. The result 782 is released at the output of the ALU 700 and can be stored in a register in the Registers 702 corresponding to the third operand (S2). In a specific example, the ALU 700 is configured to apply the function to the first operand (S0) and second operand (S1) to derive an initial Boolean result. The ALU 700 also applies the function to the initial Boolean result and the third operand to derive an updated result, corresponding to ncnt, which is released at the output of the ALU 700.

It is to be appreciated that the circuit 700 is an exemplary circuit and has been provided for the purpose of illustration only. Practical implementation of processors making use of the invention may differ from the example shown without detracting from the spirit of the invention.

It is to be appreciated that many suitable components for implementing a practical processor having the above described functionality are possible and will become readily apparent to the person skilled in the art in light of the present description. The specific combination of hardware elements used in practical implementations is not critical to the invention and therefore will not be described in detail here.

In addition, although the present invention has been described in considerable detail with reference to certain preferred embodiments thereof, variations and refinements are possible. Therefore, the scope of the invention should be limited only by the appended claims and their equivalents.

1. A processor suitable for executing machine instructions, said processor comprising:
a. an input for receiving a machine instruction, the received machine instruction defining a first operand, a second operand, a third operand and a function to be applied to the first operand, the second operand and third operand;
b. a logic module for:
i. applying the function to the first operand and second operand to obtain an initial Boolean result;
ii. applying the function to the initial Boolean result and the third operand to derive an updated result;
iii. modifying the third operand to correspond to the updated result.

2. A processor as defined in claim 1, wherein applying the function to the initial Boolean result to derive the updated result includes setting the updated result to correspond to the initial Boolean result.

3. A processor as defined in claim 1, wherein applying the function to the initial Boolean result and the third operand to derive the updated result includes processing the third operand to set the updated result to correspond to a selected one of the initial Boolean result and the third operand.

4. A processor as defined in claim 1, wherein applying the function to the initial Boolean result and the third operand to derive the updated result includes processing the third operand to set the updated result to correspond to a selected one of the initial Boolean result and a modified version of the third operand.

5. A processor as defined in claim 1, wherein the function defined by the machine instruction includes an operation and an operation modifier, the logic module being configured for:
i. applying the operation to the first operand and second operand to obtain the initial Boolean result;
ii. applying the operation modifier to the initial Boolean result and the third operand to derive the updated result.

6. A processor as defined in claim 5, wherein the operation modifier is selected from a set of available operation modifiers including at least a first modifier type, a second modifier type and a third modifier type.

7. A processor as defined in claim 6, wherein:
a. when the operation modifier conveys a first modifier type, the logic module is configured for processing the initial Boolean result to derive the updated result by setting the updated result to correspond to the initial Boolean result;
b. when the operation modifier conveys a second modifier type, the logic module is configured for processing the third operand to set the updated result to correspond to a selected one of the initial Boolean result and the third operand;
c. when the operation modifier conveys a third modifier type, the logic module is configured for processing the third operand to set the updated result to correspond to a selected one of the initial Boolean result and a modified version of the third operand.

8. A processor as defined in claim 5, wherein the logic module includes:
a. a first logic module for applying the operation to the first operand and second operand to obtain the initial Boolean result; and
b. a second logic module in communication with said first logic module, said second logic module being configured for:
i. applying the operation modifier to the initial Boolean result and to the third operand to derive the updated result; and
ii. modifying the third operand to correspond to the updated result.

9. A processor as defined in claim 1, wherein:
a. when the function conveys a first function type, the logic module is configured for processing the initial Boolean result to derive the updated result by setting the updated result to correspond to the initial Boolean result;
b. when the function conveys a second function type, the logic module is configured for processing the third operand to set the updated result to correspond to a selected one of the initial Boolean result and the third operand;
c. when the function conveys a third function type, the logic module is configured for processing the third operand to set the updated result to correspond to a selected one of the initial Boolean result and a modified version of the third operand.

10. A processor as defined in claim 1, wherein the processor comprises memory devices in communication with the logic module for storing the first operand, the second operand and the third operand.

11. A processor as defined in claim 10, wherein the memory devices include respective registers for storing the first operand, the second operand and the third operand.

12. A processor as defined in claim 12, wherein modifying the third operand to correspond to the updated result including storing the updated result in the register storing the third operand.

13. A processor suitable for executing machine instructions, said processor comprising:
a. an input for receiving a machine instruction, the received machine instruction defining a first operand, a second operand, a third operand and a function to be applied to the first operand, the second operand and third operand;
b. a logic module for:
i. applying the function to the third operand to derive a preliminary result indicator;
ii. in dependence of the derived preliminary result indicator, selectively applying the function to the first operand and second operand to update the derived preliminary result indicator;
iii. storing the derived preliminary result indicator in a memory associated with the third operand.

14. A processor as defined in claim 13, wherein applying the function to the third operand to derive the preliminary result indicator includes processing the third operand to set the preliminary result indicator to correspond to a modified version of the third operand.

15. A processor as defined in claim 13, wherein the function defined by the machine instruction includes an operation and an operation modifier, the logic module being configured for:
i. applying the operation modifier to the third operand to derive the preliminary result indicator;
ii. applying the operation to the first operand and the second operand to derive a Boolean result;
iii. conditionally using the Boolean result to update the preliminary result indicator.

16. A processor as defined in claim 15, wherein the operation modifier is selected from a set of available operation modifiers including at least a first modifier type, a second modifier type and a third modifier type.

17. A processor as defined in claim 16, wherein:
a. when the operation modifier conveys a first modifier type, the logic module is configured for updating the preliminary result indicator by setting the derived preliminary result indicator to correspond to the Boolean result;
b. when the operation modifier conveys a second modifier type, the logic module is configured for perfoiniing an update of the preliminary result indicator when the preliminary result indicator conveys a pre-determined value, the update of the preliminary result indicator including setting the derived preliminary result indicator to correspond to the Boolean result;
c. when the operation modifier conveys a third modifier type, the logic module is configured for performing an update of the preliminary result indicator by:
i. when the preliminary result indicator conveys the pre-determined value, setting the derived preliminary result indicator to correspond to the Boolean result;
ii. when the preliminary result indicator is different from the pre-determined value, modifying the preliminary result indicator.

18. A processor as defined in claim 15, wherein the logic module includes:
a. a first logic module for applying the operation modifier to the third operand to derive the preliminary result indicator;
b. a second logic module for:
i. applying the operation to the first operand and second operand to obtain the Boolean result;
ii. in dependence of the derived preliminary result indicator, selectively updating the derived preliminary result indicator based on the Boolean result.
iii. storing the derived preliminary result indicator in a memory associated with the third operand.

19. A processor as defined in claim 13, wherein:
a. when the function conveys a first function type, the logic module is configured for updating the preliminary result indicator by setting the derived preliminary result indicator to correspond to a Boolean result obtained by applying the function to the first operand and second operand;
b. when the function conveys a second function type, the logic module is configured for updating the preliminary result indicator to a selected one of the third operand and the Boolean result obtained by applying the function to the first operand and second operand;
c. when the function conveys a third function type, the logic module is configured for updating the preliminary result indicator to a selected one of a modified version of the third operand and the Boolean result obtained by applying the function to the first operand and second operand.

20. A processor as defined in claim 13, wherein the processor comprises memory devices in communication with the logic module for storing the first operand, the second operand and the third operand.

21. A processor as defined in claim 20, wherein the memory devices include respective registers for storing the first operand, the second operand and the third operand.

22. A process implemented by a processor having a logic module, said process comprising:
a. receiving a machine instruction, the received machine instruction defining a first operand, a second operand, a third operand and a function to be applied to the first operand, the second operand and third operand;
b. using the logic module of the processor:
i. applying the function to the first operand and second operand to obtain an initial Boolean result;
ii. applying the function to the initial Boolean result and the third operand to derive an updated result;
iii. storing the updated result in a memory unit associated with the third operand so that the third operand is modified to correspond to the updated result.

23. A process as defined in claim 22, wherein applying the function to the initial Boolean result and the third operand to derive the updated result includes setting the updated result to correspond to the initial Boolean result.

24. A process as defined in claim 22, wherein applying the function to the initial Boolean result and the third operand to derive the updated result includes processing the third operand to set the updated result to correspond to a selected one of the initial Boolean result and the third operand.

25. A process as defined in claim 22, wherein applying the function to the initial Boolean result and the third operand to derive the updated result includes processing the third operand to set the updated result to correspond to a selected one of the initial Boolean result and a modified version of the third operand.

26. A process as defined in claim 22, wherein the function defined by the machine instruction includes an operation and an operation modifier, the process comprising using the logic module of the processor for:
i. applying the operation to the first operand and second operand to obtain the initial Boolean result;
ii. applying the operation modifier to the initial Boolean result and the third operand to derive the updated result.

27. A process as defined in claim 26, wherein the operation modifier is selected from a set of available operation modifiers including at least a first modifier type, a second modifier type and a third modifier type.

28. A process as defined in claim 27, wherein:
a. when the operation modifier conveys a first modifier type, said process comprising using the logic module for processing the initial Boolean result to derive the updated result by setting the updated result to correspond to the initial Boolean result;
b. when the operation modifier conveys a second modifier type, said process comprising using the logic module for processing the third operand to set the updated result to correspond to a selected one of the initial Boolean result and the third operand;
c. when the operation modifier conveys a third modifier type, said process comprising using the logic module for processing the third operand to set the updated result to correspond to a selected one of the initial Boolean result and a modified version of the third operand.

29. A process as defined in claim 22, comprising:
a. when the function conveys a first function type, using the logic module for processing the initial Boolean result to derive the updated result by setting the updated result to correspond to the initial Boolean result;
b. when the function conveys a second function type, using the logic module for processing the third operand to set the updated result to correspond to a selected one of the initial Boolean result and the third operand;
c. when the function conveys a third function type, using the logic module for processing the third operand to set the updated result to correspond to a selected one of the initial Boolean result and a modified version of the third operand.

30. A process implemented by a processor having a logic module, said process comprising:
a. receiving a machine instruction, the received machine instruction defining a first operand, a second operand, a third operand and a function to be applied to the first operand, the second operand and third operand;
b. using the logic module:
i. applying the function to the third operand to derive a preliminary result indicator;
ii. in dependence of the derived preliminary result indicator, selectively applying the function to the first operand and second operand to update the derived preliminary result indicator;
c. storing the derived preliminary result indicator in a memory associated with the third operand.

31. A process as defined in claim 30, wherein applying the function to the third operand to derive the preliminary result indicator includes processing the third operand to set the preliminary result indicator to correspond to a modified version of the third operand.

32. A process as defined in claim 30, wherein the function defined by the machine instruction includes an operation and an operation modifier, the process comprising:
i. applying the operation modifier to the third operand to derive the preliminary result indicator;
ii. applying the operation to the first operand and the second operand to derive a Boolean result;
iii. conditionally using the Boolean result to update the preliminary result indicator.

33. A process as defined in claim 32, wherein the operation modifier is selected from a set of available operation modifiers including at least a first modifier type, a second modifier type and a third modifier type.

34. A process as defined in claim 33, wherein:
a. when the operation modifier conveys a first modifier type, the logic module is used for updating the preliminary result indicator by setting the derived preliminary result indicator to correspond to the Boolean result;
b. when the operation modifier conveys a second modifier type, the logic module is used for performing an update of the preliminary result indicator when the preliminary result indicator conveys a pre-determined value, the update of the preliminary result indicator including setting the derived preliminary result indicator to correspond to the Boolean result;
c. when the operation modifier conveys a third modifier type, the logic module is used to perform an update of the preliminary result indicator by:
i. when the preliminary result indicator conveys the pre-determined value, setting the derived preliminary result indicator to correspond to the Boolean result;
ii. when the preliminary result indicator is different from the pre-determined value, modifying the preliminary result indicator.

35. A process as defined in claim 30, wherein:
a. when the function conveys a first function type, said process comprising using the logic module for updating the preliminary result indicator by setting the derived preliminary result indicator to correspond to a Boolean result obtained by applying the function to the first operand and second operand;
b. when the function conveys a second function type, said process comprising using the logic module for updating the preliminary result indicator to a selected one of the third operand and the Boolean result obtained by applying the function to the first operand and second operand;
c. when the function conveys a third function type, said process comprising using the logic module for updating the preliminary result indicator to a selected one of a modified version of the third operand and the Boolean result obtained by applying the function to the first operand and second operand.

36. A computer readable storage medium storing a set of computer-readable instructions, said computer-readable instructions being configured to be executed by a processor having a logic module suitable for executing at least some of the computer-readable instructions in said set, wherein said set of computer-readable instructions includes a machine instruction defining:
a. a first operand;
b. a second operand;
c. a third operand; and
d. a function to be applied to the first operand, the second operand and third operand;
wherein when executed by said logic module, the machine instruction causes the logic module to:
i. apply the function to the first operand and second operand to obtain an initial Boolean result;
ii. apply the function to the initial Boolean result and the third operand to derive an updated result;
iii. store the updated result in a memory of the processor associated with the third operand.

37. A computer readable storage medium as defined in claim 36, wherein:
when the function conveys a first function type, the logic module when executing the machine instruction is caused to process the initial Boolean result to derive the updated result by setting the updated result to correspond to the initial Boolean result;
when the function conveys a second function type, the logic module when executing the machine instruction is caused to process the third operand to set the updated result to correspond to a selected one of the initial Boolean result and the third operand;
when the function conveys a third function type, the logic module when executing the machine instruction is caused to process the third operand to set the updated result to correspond to a selected one of the initial Boolean result and a modified version of the third operand.

38. A computer readable storage medium storing a set of computer-readable instructions, said computer-readable instructions being configured to be executed by a processor having a logic module suitable for executing at least some of the computer-readable instructions in said set, wherein said set of computer-readable instructions includes a machine instruction defining:
a. a first operand;
b. a second operand;
c. a third operand; and
d. a function to be applied to the first operand, the second operand and third operand;
wherein when executed by said logic module, the machine instruction causes the logic module to:
i. apply the function to the third operand to derive a preliminary result indicator;
ii. in dependence of the derived preliminary result indicator, selectively apply the function to the first operand and second operand to update the derived preliminary result indicator;
iii. store the derived preliminary result indicator in a memory of the processor associated with the third operand.

39. A computer readable storage medium as defined in claim 38, wherein:
a. when the function conveys a first function type, the logic module when executing the machine instruction is caused to update the preliminary result indicator by setting the derived preliminary result indicator to correspond to a Boolean result obtained by applying the function to the first operand and second operand;
b. when the function conveys a second function type, the logic module when executing the machine instruction is caused to update the preliminary result indicator to a selected one of the third operand and the Boolean result obtained by applying the function to the first operand and second operand;
c. when the function conveys a third function type, the logic module when executing the machine instruction is caused to update the preliminary result indicator to a selected one of a modified version of the third operand and the Boolean result obtained by applying the function to the first operand and second operand.

40. A computer program product storing a program element suitable to be executed by a computing apparatus for implementing a process for parsing a logical expression to create a set of computer-readable instructions, the set of computer-readable instructions being suitable for causing a processor to evaluate a Boolean result associated with the logical expression, the logical expression being comprised of a plurality of sub-expressions, wherein the program element when executed by the computing apparatus is configured for:
a. processing the sub-expressions in said plurality of sub-expressions to generate the set of computer-readable instructions, the processed sub-expressions being associated with respective nesting levels relative to the logical expression being evaluated, wherein at least one computer readable instruction associated with a sub-expression of the plurality of sub-expressions defining:
i. a first operand;
ii. a second operand;
iii. a third operand; and
iv. a function to be applied to the first operand, the second operand and third operand;
wherein the function in said at least one computer readable instruction is such that, when executed by the processor, causes the third operand to convey information related to a combination of:
(1) an intermediate result of the logical expression being evaluated; and
(2) a level of nesting associated with a sub-expression with which the at least one computer readable instruction is associated;
b. storing the set of generated computer-readable instructions on a memory device.

41. A computer program product as defined claim 40, wherein the program element when executed by the computing apparatus is configured for:
a. processing the logical expression to derive a normalized logical expression, said normalized logical expression including Boolean operators selected from a set of available Boolean operators;
b. generate the set of computer-readable instructions based on sub-expressions in the normalized logical expression.

42. A computer program product medium as defined claim 40, wherein the logical expression is a normalized logical expression including Boolean operators selected from a set of available Boolean operators.

43. A computer program product as defined claim 42, wherein the set of available Boolean operators consists of OR and NOT operators.

44. A computer program product as defined claim 43, wherein the set of available Boolean operators consists of AND and NOT operators.

45. A computer program product as defined in claim 40, wherein the function is a function of a first type such that, when executed by the processor, the function of the first type is applied to the first operand and second operand to obtain an initial Boolean result and the third operand is set to correspond to the initial Boolean result.

46. A computer program product as defined in claim 45, wherein the function is a function of a second type such that, when executed by the processor:
a. the function of the second type is applied to the first operand and second operand to obtain an initial Boolean result; and
b. the third operand is caused to correspond to a selected one of the initial Boolean result and the third operand.

47. A computer program product as defined in claim 46, wherein the function is a function of a third type such that, when executed by the processor:
a. the function of the third type is applied to the first operand and second operand to obtain an initial Boolean result; and
b. the third operand is caused to correspond to a selected one of the initial Boolean result and a modified version of the third operand.

48. A computer program product storing a program element suitable to be executed by a computing apparatus for implementing a process for parsing a logical expression to create a set of computer-readable instructions, the set of computer-readable instructions being suitable for causing a processor to evaluate a Boolean result associated with the logical expression, the logical expression being comprised of a plurality of sub-expressions, each sub-expression being associated with a respective nesting level relative to the logical expression being evaluated, wherein said process comprises processing a sub-expression of said plurality of sub-expressions to generate at least one computer readable instruction, said at least one computer readable instruction defining a function, wherein the function is such as to cause information to be stored in a memory associated with a processor executing the set of computer-readable instructions, said information being related to a combination of:
i. a preliminary result of the logical expression being evaluated; and
ii. a level of nesting associated with the sub-expression processed to generated the least one computer readable instruction.

49. A computer program product storing a program element suitable to be executed by a computing apparatus for implementing a process for parsing a logical expression to create a set of computer-readable instructions, the set of computer-readable instructions being suitable for causing a processor to evaluate a Boolean result associated with the logical expression, wherein said process comprises processing the logical expression to generate at least one computer readable instruction defining:
a. a first operand;
b. a second operand;
c. a third operand; and
d. a function to be applied to the first operand, the second operand and third operand;
wherein when executed by the processor, the machine instruction causes the processor:
i. apply the function to the first operand and second operand to obtain an initial Boolean result;
ii. apply the function to the initial Boolean result and the third operand to derive an updated result;
iii. store the updated result in a memory of the processor associated with the third operand.

50. A computer program product as defined in claim 49, wherein the third operand conveys information being related to a combination of:
i. a preliminary result of the logical expression being evaluated; and
ii. a level of nesting associated with the sub-expression processed to generated the least one computer readable instruction.
